(19) United States
(12) Patent Application Publication
(10) Pub. No.: US 2012/0261156 A1
(43) Pub. Date: Oct. 18, 2012

(54) PROTECTION DEVICE FOR A CABLE CONNECTION

(75) Inventors: William V. Dower, Austin, TX (US); Jerome A. Pratt, Round Rock, TX (US); Dean C. Krenz, Austin, TX (US); John P. Lammers, Austin, TX (US); Gary D. Woolston, Austin, TX (US); Scott D. Turner, Austin, TX (US)

(73) Assignee: 3M Innovative Properties Company

(21) Appl. No.: 13/414,887

(22) Filed: Mar. 8, 2012

Related U.S. Application Data
(60) Provisional application No. 61/474,571, filed on Apr. 12, 2011.

(51) Int. Cl. H02G 3/06

(52) U.S. Cl. 174/93

(57) ABSTRACT

The present invention is directed to a low profile protection device for protecting a cable connection. The protection device includes an elastomeric base layer, a gel sealant material coated on the elastomeric base layer; and a closure mechanism disposed along the protection device such that the protection device exerts a compressive force around the cable connection when disposed in its assembled state. The elastomeric base layer has a first longitudinal edge and a second longitudinal edge, wherein the first and second longitudinal edges are substantially parallel in an assembled state and wherein a portion of the first longitudinal edge is obliquely oriented to a portion of the second longitudinal edge in an unassembled state.

### CROSS REFERENCE TO RELATED APPLICATION

This application claims the benefit of U.S. Provisional Patent Application No. 61/474571, filed Apr. 12, 2011, the disclosure of which is incorporated by reference herein in its entirety.

### BACKGROUND OF THE INVENTION

1. Field of the Invention

The present invention relates to a protection device to protect a connection between two cables, or the connection between a cable and a housing. In particular, the present invention relates to a protection device having a gel sealant material disposed on an elastomeric base layer.

2. Background

Telecommunication cables are ubiquitous and used for distributing all manner of data across vast networks. As telecommunication cables are routed across data networks, it is necessary to periodically connect the cable to other cables or equipment.

At each point where a cable connection is made, it may be necessary to provide protection for the cable connection and to protect the cable interfaces from environmental contaminants. This can be accomplished by wrapping the cable connection in a tape or mastic and/or placing the cable connection in a protective enclosure. Commonly, the enclosure has one or more ports through which cables can enter and/or exit the enclosure. Once the cables are routed into the enclosure, the cable connections can be made.

The cable can, for example, be a telecommunications cable, a power cable, an optical fiber cable, coaxial cable, or any other type of cable. The cable connection can be made via a conventional splice or a connector and may require protection from the effects of the environment in which it is located and, more particularly, requires protection from the entry of moisture, dirt, salt, acid rain, or other environmental contaminants.

Many closures can be relatively large and bulky and are not well suited to applications requiring a single closure to protect a single connection point between two or more communication cables, between a cable and a housing (e.g. a cabinet, a bulkhead, a larger enclosure or housing for a piece of equipment) or between a cable and a piece of equipment, especially when the cable connections are densely placed or ganged connections such as one might find in cell tower installations. Standard tape and mastic wrap sealing solutions require that the wrap be cut away and disposed of and a fresh wrap applied whenever the cable connection needs maintenance or needs to be inspected, and are often difficult to apply and remove in installations which have little free space around the connections to be protected. Thus, a need exists for a smaller, more craft friendly protection device which will fit in tight spaces and which has improved workability in the field.

### SUMMARY

The present invention is directed to a low profile protection device for protecting a cable connection. In one exemplary embodiment, the protection device includes an elastomeric base layer, a gel sealant material coated on the elastomeric base layer, and a closure mechanism disposed along the protection device such that the protection device exerts a compressive force around the cable connection when disposed in its assembled state. The elastomeric base layer has a first longitudinal edge and a second longitudinal edge, wherein the first and second longitudinal edges are substantially parallel in an assembled state and wherein a portion of the first longitudinal edge is obliquely oriented to a portion of the second longitudinal edge in an unassembled state.

In one exemplary aspect, the low profile protection device can be used to protect an asymmetric cable connection.

In another exemplary embodiment, the protection device includes an elastomeric base layer, a gel sealant material coated on the elastomeric base layer; and a closure mechanism disposed along the protection device such that the protection device has an outer surface that conforms to an external surface of the cable connection such that the outer surface of protection device is less than about 6.5 mm from the external surface of the cable connection.

### BRIEF DESCRIPTION OF THE DRAWINGS

The present invention will be further described with reference to the accompanying drawings wherein like reference numerals refer to like parts in the several views, and wherein:

FIG. 1 is an isometric view of an exemplary low profile protection device according to an embodiment of the present invention;

FIG. 2 is a top view of an exemplary elastomeric base layer in an unassembled state according to an embodiment of the present invention;

FIGS. 3A-3C illustrate the installation of another exemplary low profile protection device over a cable connection according to an embodiment of the present invention;

FIG. 3D is a cross section of an exemplary low profile protection device according to an embodiment of the present invention; and

FIGS. 4A-4D illustrate the installation of another exemplary low profile protection device over a cable connection according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention relates to an exemplary low profile sealing/protection device to protect a point where a grounding connection is made, a connection between two or more cables, or a connection between a cable and a housing or piece of equipment. The exemplary protection device can also be used to repair the sheath of a cable that has been damaged such as can occur when utility crews are digging around or near buried cables. In yet another aspect, the exemplary protection device can be used to provide environmental protection at the point where a cable enters duct to prevent contaminants from entering the duct.

Many conventional connectors used in the telecommunication, cable TV and utility industries, even those having internal sealing members (i.e. O-rings), may not provide adequate environmental protection for the cable connection by themselves. Without additional external protection, water and other contaminants can penetrate the system and degrade the electrical or optical connection. To compensate for this shortcoming in the connectors, system operators will frequently place the cable connection in a molded enclosure or wrap the cable connection with tapes and/or mastics to provide the necessary protection.

However, in some applications, where it is desirable to individually protect connections in confined spaces, such as in cellular installations, there can be too little space to accommodate conventional molded enclosures. In some instances operators utilize a process that involves wrapping multiple alternating layers of tape and mastic around and over the connector and the adjacent cabling to provide a measure of environmental protection for the connection. This wrapping process can be a tedious, time consuming operation and its effectiveness is dependent on the skill of the installer. Additionally, when the wrap process is employed in aerial installations such as those that occur high up on cellular towers, the difficulty in properly using these materials is amplified and ultimately affects the safety of the technician. As the taping process is the last step, it is typically performed when the installer may be fatigued and hurrying to finish, thus it is particularly prone to defects in technique. Finally, the tape/mastic wrapping must be cut away during routine inspection and maintenance operations and fresh tape must be reapplied when these operations are complete, requiring additional time and expense.

Thus, what is needed is a new form of protective device which can be quickly and easily applied in confined spaces, such as closely packed connector arrays found on cellular tower antennas, to replace the cumbersome tape process or the more bulky molded plastic enclosures.

The low profile protection device, as described herein, is of simple construction, and uses comparatively few components to enable easy assembly in the field, even at difficult or inaccessible locations.

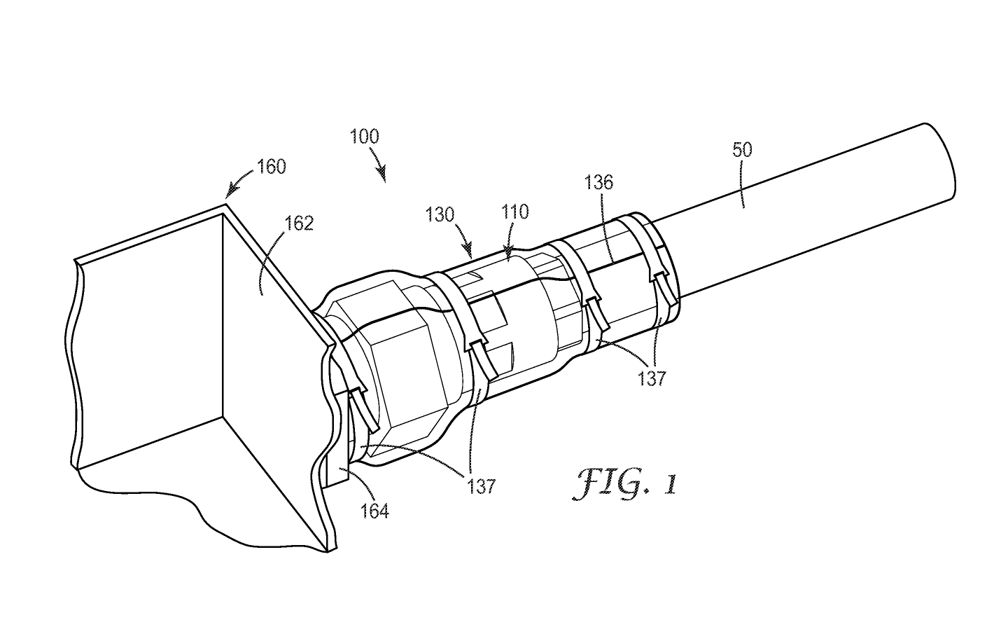

FIG. 1 shows a first exemplary embodiment of a low profile protection device 100 of the current invention installed over connection between a cable 50 and equipment housing or box 160. The cable can, for example, be a telecommunications cable, a power cable, an optical fiber cable, coaxial cable, or any other type of cable. Cable 50 can have a connector 110 mounted on a terminal end of the cable that can be connected to a receptacle 164 mounted in a wall 162 of box 160. The protection device protects the cable connection from the ingress of moisture, dirt, salt, acid rain, or other environmental contaminants.

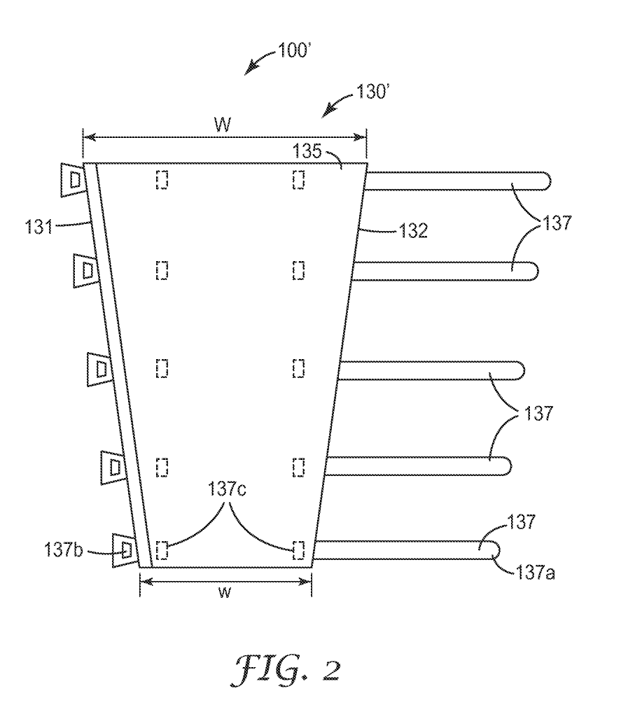

Protection device 100 includes an elastomeric base layer 130, a gel sealant material 135 (FIG. 2) coated on a first major surface of the elastomeric base layer; and a closure mechanism disposed along the protection device. The closure mechanism ensures that the protection device exerts a compressive force around the cable connection when disposed in its assembled state. The closure mechanism shown in FIG. 1 comprises four straps 137 spaced apart along the length of protection device 100. Straps 137 can be in the form of cable ties, a hook and loop strap such as SCOTCH™ Cord Organizing Straps available from 3M, or Hook & Loop Binding Strips available from Cables to Go (Moraine, Ohio). In an alternative aspect straps 137 can be in the form of spaced apart bands of tape wrapped around the cable connection surrounded by the elastomeric base layer. In an exemplary embodiment, one or more rigid or semi-rigid bridging elements can span between adjacent straps to provide a more uniform pressure distribution along the seam joining the first and second longitudinal edges of the sealing device.

In an alternative aspect, the closure mechanism can be one of a zipper, a magnetic closure, an eyelet and lace closure, an eyelet and tab closure, a hook and loop style closure, a series of parallel fastening straps or a combination thereof.

In an exemplary aspect, the outer surface of the low profile protection device substantially conforms to an external surface of the cable connection such that the outer surface of the protection device is less than about 6.5 mm from the external surface of the cable connection. The close fitting nature of the exemplary protection device becomes particularly important in locations such as the array of cable attachment points are positioned very closely together such as on a radio amplifier at the base of a cell tower, or on MIMO (Multi-Input/Multi-Output) antenna which can have a very large number of closely spaced connections on a small surface area. For example the spacing between adjacent ports on some antennas assemblies is about 13 mm. Thus, any protection device used in these installations must have a thickness of less than about 6.5 mm.

Examples of MIMO antennas which present special challenges to conventional rigid-walled closures and tape sealing approaches include triple-band directional antennas, such as Type No. 742-270 available from Kathrein Inc. (Medford, Oreg.), Dual Polarized antennas, such as OPTOMIZER® Panel Dual Polarized Antenna APX16DWV-16DWVS available from Radio Frequency Systems (Meriden, Conn.), and the like.

In an alternative aspect, the outer surface of the low profile protection device conforms to an external surface of the cable connection such that the outer surface of the protection device is less than about 3.2 mm from the external surface of the cable connection.

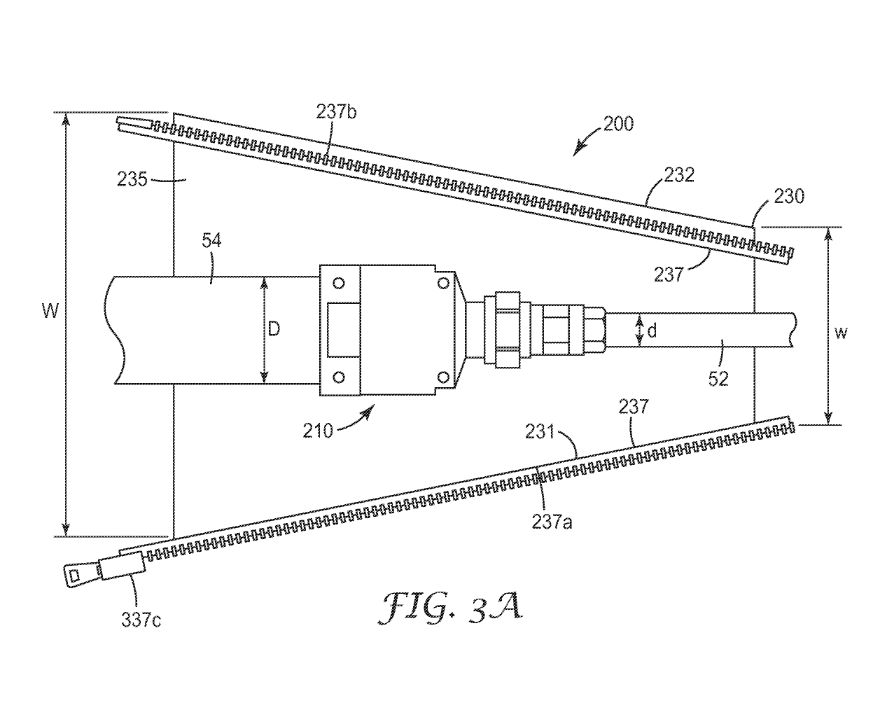

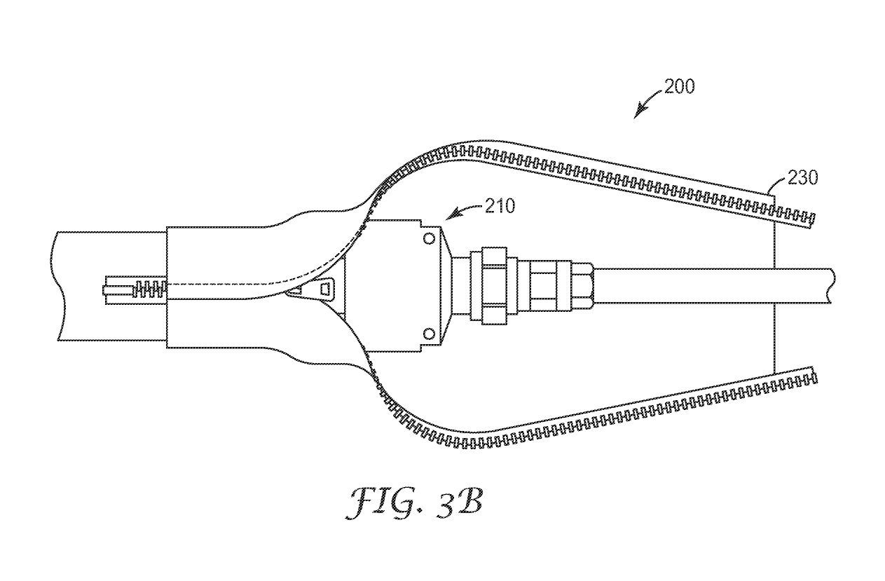

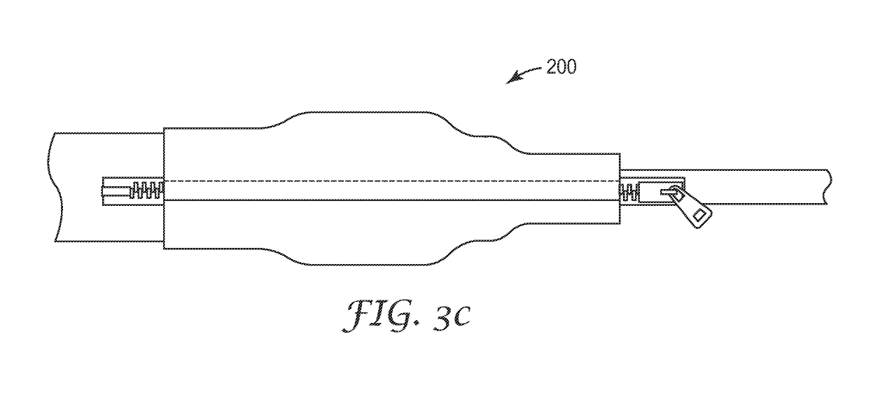

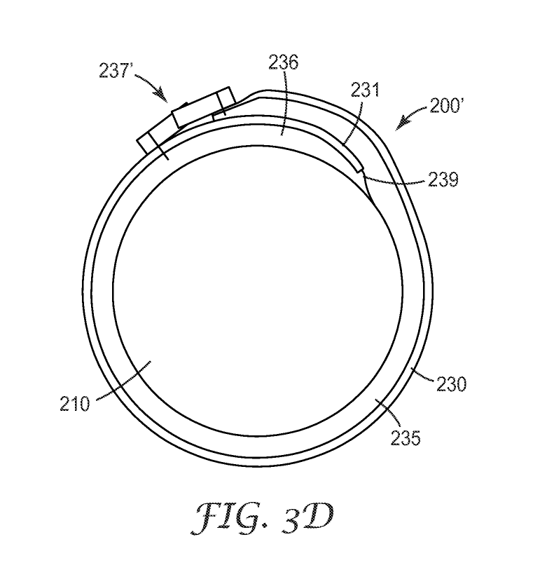

FIG. 2 shows an alternative exemplary protection device 100′ disposed in a planar/unassembled state having an elastomeric base layer 130′, a gel sealant material 135 coated on a first major surface of the elastomeric base layer; and a closure mechanism disposed along the protection device. The elastomeric base layer has a first longitudinal edge 131 and a second longitudinal edge 132 wherein at least a portion of the first longitudinal edge is obliquely oriented relative to a portion of the second longitudinal edge in an unassembled state. Elastomeric base layer 130′ has a trapezoidal shape having straight first and second longitudinal edges 131, 132 such that the width “W” at one end of the elastomeric base layer is larger than the width “w” of the base layer at a second end of the elastomeric base layer. This shape is especially useful when the cable connection to be protected is asymmetric (i.e. when the cable connection is characterized by a first diameter, D (FIG. 3A), at a first end of the cable connection that is larger than a second diameter, d, at a second end of the cable connection). In an alternative aspect, the elastomeric base layer is substantially nonrectangular. For example, the elastomeric base layer can be wider at the first end of the base layer than at the second end of the base layer.

In an alternative aspect, the longitudinal edges 131, 132 may be tapered, curved, or a combination of straight and curved sections as required by the application to transition between the width of the elastomeric base layer at its first end and the width of the elastomeric base layer at its second end. In this aspect, the longitudinal edges or a tangent to a curved portion of the longitudinal edges of the elastomeric base layer will be obliquely disposed in an unassembled state, but will be disposed substantially parallel to one another when the protection device is in an assembled state.

Another asymmetric cable connection that can be protected using the exemplary protection devices described herein can include a splitter or tapping connection. In this type of a connection, a single cable may be connected to one side of a splitting/tapping device such as a Y-shaped splice or a coaxial splitter, for example, and have two or more cables extending from a second side of the device. In order to seal between adjacent cables extending from the same side of the device, the cables may be wrapped with a small piece of a soft mastic or gel material wrap. Then an exemplary low profile protection device can be placed around the cable connection to provide the desired level of environmental protection.

In an alternative aspect the connection device used to connect two cables may be substantially larger in diameter than the cables being connected by it. In this case, the elastomeric base layer having a wider portion at an intermediate location along the length of the protection device can be envisioned.

When the protection device is assembled around the cable connection the elastomeric base layer is positioned such that the first and second longitudinal edges are disposed substantially parallel to one another. Then the closure mechanism is fastened to secure the protection device around the cable connection. Advantageously, the elastomeric base layer can be stretched so that it exerts a compressive force around the cable connection when disposed in its assembled state and secured by the closure mechanism. The closure mechanism shown in FIG. 2 comprises 5 straps 137 spaced apart along the length of protection device 100′. The free terminal tab 137a of each strap can be inserted through eyelet 137b when the protection device has been positioned around the cable connection. The terminal tab is pulled until the strap is securely fastened around the external surface of protection device by a mechanical locking mechanism such as a hook and loop closure mechanism or integral locking mechanism within the eyelet of the strap such as the locking mechanism used in a conventional cable tie.

In one exemplary aspect, the straps can be attached to the elastomeric base layer by an adhesive, being sewn in place or by passing a portion 137c of the strap through two or more pairs of slits in the base later so that the strap is effectively woven through the elastomeric base layer as shown in FIG. 2. Alternatively, a series of loops may be formed on the second major surface of the elastomeric base layer such as by sewing through which the straps may be threaded.

The elastomeric base layer supports a soft gel sealant material 135 on a first major surface of the elastomeric base layer. The gel sealant material forms the seal at the cable/connector/inlet surface when the exemplary protection device is fitted around a cable connection. The elastomeric base layer can be a fabric-backed elastomeric sheet including a rubber sheet, a plastic film, or an elastic volume compliant sheet such as a closed cell and/or open cell foam sheet, an elastic nonwoven fabric, or a combination thereof (e.g. a fabric backing on a rubber sheet for instance). Use of a fabric coating bonded to the elastomer base layer can provide improved bonding of the gel sealant layer to the base layer. The elastomeric base layer should be a material which is compatible with the gel sealant material used in the sealing member. Exemplary materials for the elastomeric base layer include vulcanized rubbers, neoprene, polyurethanes, silicones, as well as crosslinked polymer materials. In an exemplary aspect, the elastomeric base layer can have a thickness of about 1.25 mm to about 10 mm. An exemplary elastomeric base layer can be a closed cell neoprene foam having a nylon fabric face on one side, for example, item number 201400BN from Perfectex plus LLC (Huntington Beach, Calif.) or an open cell neoprene sheet having a nylon fabric face on one side, for example, a 3 mm thick neoprene foam rubber with nylon cover fabric adhered available from Seattle Fabric (Seattle, Wash.). If a closed cell foam or other non-porous substrate is chosen for the elastomeric base layer, it can provide an additional physical barrier to the entry of environmental contaminants.

The gel sealant material provides a physical barrier to the entry of environmental contaminants to the regions being protected by the gel material. Typical gel sealant materials can include oil swollen, cross-linked polymer networks. The cross-links can be either due to physical association or chemicals bonds formed between the polymer chains within the network. Exemplary oil swollen gel materials can include oil-filled thermoplastic elastomeric rubbers (e.g. styrene/rubber/styrene block copolymers), room-temperature vulcanization, (RTV) and thermoset compositions, (e.g. silicones, epoxy, urethane/isocyanates, esters, styrene-butadiene rubber (SBR), ethylene propylene diene monomer (EPDM) rubber, nitrile and butyl rubbers, etc.), and radiation cured materials including e-beam and UV/Vis radiation sensitive formulations.

One exemplary gel sealant material can comprise 70 to 95 parts by weight of mineral oil dispersed in 5 to 30 parts by weight of thermoplastic elastomer. Optionally, small concentrations (i.e. less than two parts by weight mineral oil, more preferably less than one parts by weight mineral oil of additional additives and most preferably less than 0.5 parts by weight mineral oil) may be added to the gel sealant material as needed.

The term mineral oil, as used herein, refers to any of various light hydrocarbon oils, especially distillates of petroleum. Typically, the mineral oil is a white mineral oil although other mineral oils may be used. White mineral oils are generally colorless, odorless, tasteless mixtures of saturated paraffinic and naphthenic hydrocarbons that span a viscosity range of 50-650 Saybolt Universal Seconds (5 to 132 centistokes) at 100° F. (38° C.). Nearly chemically inert, white mineral oils are essentially free of nitrogen, sulfur, oxygen and aromatic hydrocarbons. Exemplary mineral oils include KAYDOL oil available from Crompton Corporation (Middlebury, Conn.), DuoPrime 350 available from Citago Petroleum Corporation (Houston, Tex.), Crystal Plus 200T and Crystal Plus 500T available from STE Oil Company, Inc. (San Marcos, Tex.). Typically, 70 to 95 parts by weight of mineral oil, or even more typically 85 to 93 parts by weight of mineral oil are used in combination with 5 to 10 parts by weight of the at least one thermoplastic elastomer.

In an alternative embodiment, the mineral oil can be replaced fully or in part by another petroleum based oil, a vegetable oil, silicone oil, or a modified version of either of these two oil types.

Suitable thermoplastic elastomers for use in sealant material include styrene-rubber-styrene (SRS) triblock copolymers, or mixtures of SRS triblocks and styrene-rubber (SR) diblock copolymers. Exemplary styrene-rubber-styrene triblock copolymers include styrene-butadiene-styrene (SBS), styrene-isoprene-styrene (SIS), and partially or completely hydrogenated derivatives thereof, such as styrene-ethylene/butylene-styrene (SEBS), styrene-ethylene/propylene-styrene (SEPS), styrene-ethylene/ethylene/propylene-styrene (SEEPS), and combinations thereof. Examples of commercially available suitable SEBS block copolymers for use in the exemplary sealant material include trade designated “KRATON G-1651” and “KRATON G-1633” Block Copolymers, both of which are commercially available from Kraton Polymers (Houston, Tex.). Examples of commercially available suitable SR diblock copolymers include trade designated “KRATON G-1701” and “KRATON G-1702” Block Copolymers both of which are commercially available from Kraton Polymers (Houston, Tex.), and “SEPTON S 1020” High Performance Thermoplastic Rubber which is commercially available from Kuraray Company (Tokyo, Japan). An exemplary commercially available suitable SEPS and SEEPS block copolymers for use in the exemplary sealant material include trade designated “SEPTON S 4055” or “SEPTON S 4077” High Performance Thermoplastic Rubber which are commercially available from Kuraray Company (Tokyo, Japan). Additionally, suitable vinyl-rich block copolymers for use in the exemplary sealant material include “HYBRAR 7125” and “HYBRAR 7311” High Performance Thermoplastic Rubbers, which are also commercially available from Kuraray Company (Tokyo, Japan). A suitable maximum concentration of the block copolymer in the gel sealant material is about 30% by weight, based on the entire weight of gel sealant material.

Other additives which may be added to the exemplary gel sealing material of the current invention can include cure catalysts, stabilizers, antioxidants, biocides, colorants (e.g. carbon black, talc, or dyes), thermally conductive fillers, etc. Suitable stabilizers and antioxidants include phenols, phosphites, phosphorites, thiosynergists, amines, benzoates, and combinations thereof. Suitable commercially available phenolic-based antioxidants include trade designated “IRGANOX 1035”, “IRGANOX 1010”, and “IRGANOX 1076” Antioxidants and Heat Stabilizers for wire and cable applications, commercially available from Ciba Specialty Chemicals Corp. (Tarrytown, N.Y.). A suitable maximum concentration of stabilizers or antioxidants in the gel sealant material is about 1% by weight, based on the entire weight of the gel sealant material. When forming the gel sealant material, stabilizers and antioxidants may be dissolved or dispersed in the mineral oil prior to combining the diblock copolymer with the mineral oil.

The gel sealant material can be melted and coated onto a fabric-faced neoprene sheet (item number 201400BN available from Perfectex plus LLC, Huntington Beach, Calif.). In one exemplary aspect, the gel sealant is a mixture of 5% Kraton G1633 in Kaydol oil, with 0.2% Irganox 1010 antioxidant. The sealant material can be melted in a hot melt dispenser that has a reservoir temperature of about 170° C. to about 180° C. The melted sealant material is dispensed onto the elastomeric base layer and coated to the desired thickness via a standard knife coating technique. The resulting sheets of material can be cut to the desired size after the elastomeric base layer has been coated with the gel sealant material. In an alternative aspect, the elastomeric base layer can be cut to size prior to application of the gel sealant material. In one alternative method, the cut sheet of the elastomeric base layer can be inserted into a mold and the gel sealant material can be injected under pressure.

In an alternative aspect, the gel sealant is a mixture of 9% Kraton G1651 in Kaydol oil with 0.2% Irganox 1010 antioxidant and a trace amount (0.002%) of Raven 660R Carbon Black available from Columbian Chemicals Company (Marietta, Ga.). In another alternative aspect, the gel sealant is a mixture of about 5% Septon 54055 in Kaydol oil with 0.2% Irganox 1010 antioxidant and a trace amount (0.002%) of Raven 660R Carbon Black. In another alternative aspect, the gel sealant is a mixture of about 9% Kraton G1651 in Crystal Plus 500T oil, with 0.2% Irganox 1010 antioxidant Raven 1200 Carbon Black available from Columbian Chemicals Company (Marietta, Ga.). In another alternative aspect, the gel sealant is a mixture of about 5% Kraton G1633 in Crystal Plus 500T oil, with 0.2% Irganox 1010 antioxidant. While in another alternative aspect, the gel sealant is a mixture of about 5% Septon 54055 in Crystal Plus 350T oil, with 0.2% Irganox 1010 antioxidant and a trace amount (0.002%) of Raven 660R Carbon Black. While yet another alternative gel sealant mixture includes of about 9% Septon S4077 in Crystal Plus 350T oil, with 0.2% Irganox 1010 antioxidant.

The gel sealant material can be coated in to yield a final thickness of the gel sealant material of about 1.5 mm to about 5 mm thick on the elastomeric base layer. In an alternative aspect, the gel sealant material can be coated in to yield a final thickness of the gel sealant material of about 2.0 mm to about 2.5 mm thick on the elastomeric base layer. The thickness of the gel sealant materials can be altered depending on the configuration of the enclosure and cable connection to be protected.

A powder release agent, for example an inorganic powder, e.g. talcum powder, or glass bubbles such as 3M™ Glass Bubbles K1 available from 3M Company (St. Paul, Minn.), can be applied onto the surface of the gel sealant material to reduce the surface tack of the sealant layer. In an exemplary aspect, the powder release agent can optionally be treated with a hydrophobic coating, such as an epoxy silane surface treatment as is known in the art, to improve compatibility with the gel sealant material.

FIGS. 3A-3C illustrate the installation of a second embodiment of an exemplary low profile protection device designed to fit over an asymmetric cable connection 210 between a small diameter, “d”, cable 52 and a larger diameter, “D”, cable 54 in accordance with the current invention. Protection device 200 includes an elastomeric base layer 230, a gel sealant material 235 coated on a first major surface of the elastomeric base layer; and a closure mechanism 237 disposed along the length of the protection device. The closure mechanism ensures that the protection device exerts a compressive force around the cable connection when disposed in its assembled state.

The closure mechanism shown in FIGS. 3A-3C comprises a zipper. The zipper can be separated into two disconnected track sections 237a, 237b that can be sewn along the first and second longitudinal edges of the base layer as shown in FIG. 3A. The zipper is oriented such that the zipper pull 237c is oriented so that it faces away from the surface of the gel sealant layer. The zipper can be longer than the longitudinal edges of the protection device such that the disconnected track sections 237a, 237b extend beyond the edges of the elastomeric base layer. This design has the advantage that the zipper can be initiated while the sealant device is not under tension, and that once the zipper is completely closed, there would not be any residual elastic forces that would cause the zipper to come open again. Closing the zipper over the cable connection will stretch the protection device so that it is tautly fitted over the connection such that it exerts a compressive or inward compressive force. This compressive force ensures good wetting of the gel sealant material around the cables and the cable connection contained therein and provides for a good environmental seal of the cable connection.

FIG. 3A shows protection device 200 in an unassembled state. The elastomeric base layer 230 is wider at the end of the protection device configured to fit around the larger cable 54 and characterized by a first width, “W”, and narrower at the end of the protection device configured to fit around the small cable 52, which is characterized by a second width, “w”. FIG. 3B shows protection device 200 in a partially assembled state in which the zipper has been closed about one third of the length of the protection device. FIG. 3C shows protection device 200 in a fully assembled state. Note that in FIG. 3C that the zipper is covered by a portion of the elastomeric base layer to give a sleek and clean assembly. In one exemplary aspect, the additional portion of the elastomeric base layer that covers the zipper can be held to the body of the closure with a mechanical hook-and-loop attachment mechanism to further protect the zipper and the sealant against the environment. Comparing FIGS. 3A and 3C shows how the first longitudinal edge 231 is obliquely oriented relative the second longitudinal edge 232 of the protection device in an unassembled state and how the first and second longitudinal edges can be parallel to one another in an assembled state.

Referring to FIG. 3D, protection device 200′ is disposed around cable connection 210. The closure mechanism 237′ (i.e. the zipper) secures the first longitudinal edge 231′ in between the cable connection and another portion of the protection device creating an overlap region 236. A triple point 239 occurs where the first longitudinal edge is over wrapped by another portion of the protection device. This triple point region should be properly engineered and controlled so that a good seal is formed. Advantageously, in this exemplary design, the zipper, itself, is not part of the seal. The zipper pulls the gel sealant on the elastomeric base layer into place, and as the zipper passes beyond the sheet, the excess material length of the zipper allows there to be no force on the sliding portion of the zipper, so that it will not spontaneously unzip. Alternatively, a locking zipper may be used.

While FIGS. 3A-3C show that the zipper runs from the larger cable side to the smaller cable side of the protection device, the zipper can be started at the smaller cable side and run to the larger cable side of the protection device.

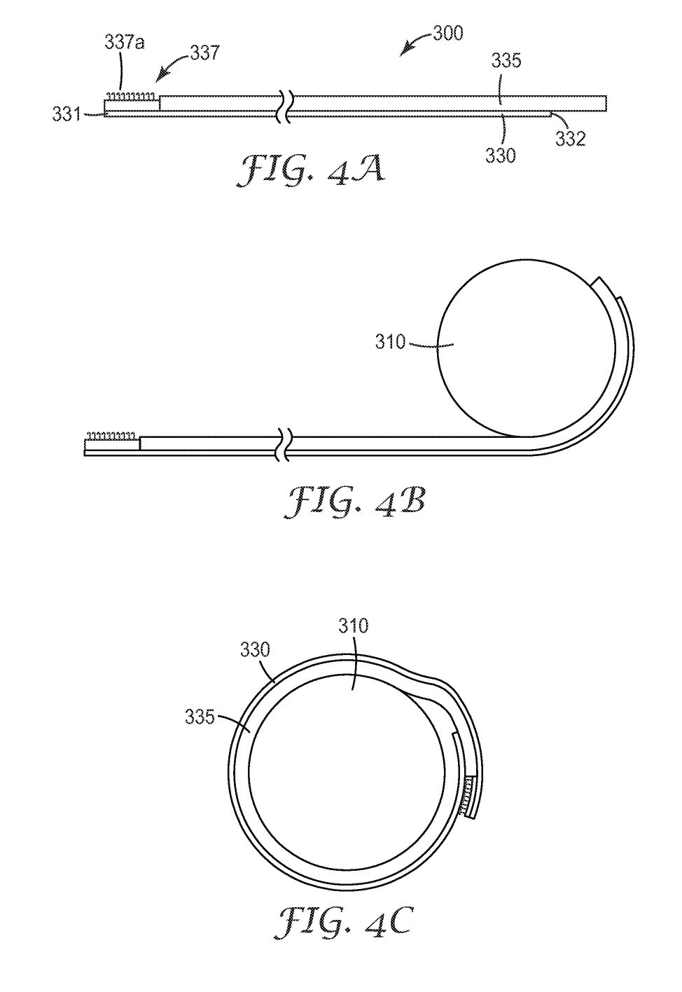

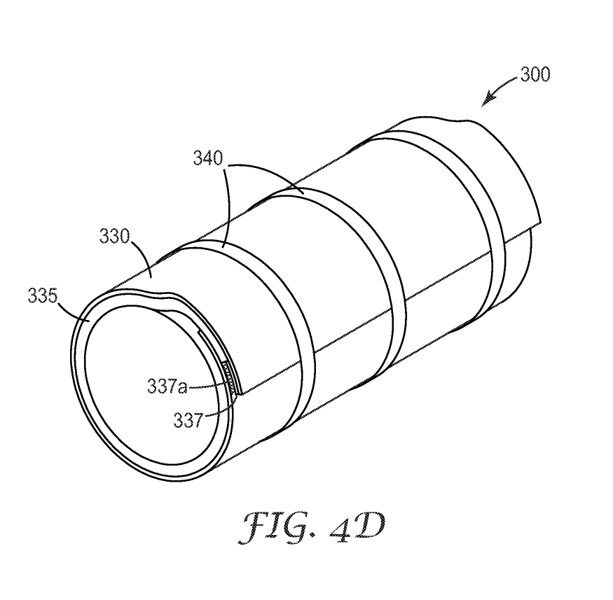

FIGS. 4A-4C illustrate the installation of a third embodiment of a low profile exemplary sealing device 300 over cable connection 310. Protection device 300 includes an elastomeric base layer 330, a gel sealant material 335 coated on a first major surface of the elastomeric base layer; and a closure mechanism 337 disposed along the length of the protection device. The closure mechanism ensures that the protection device exerts a compressive force around the cable connection when disposed in its assembled state. The closure mechanism shown in FIGS. 4A-4D comprises a hook and loop closure mechanism.

FIG. 4A shows protection device 300 in an unassembled state. The gel sealant material is applied to the elasomeric base layer as described previously. However, a strip of the elastomeric base layer adjacent to the first longitudinal edge 331 of the elastomeric base layer is left bare. A strip of hooks 337a can be bonded or sewn to this bare portion of the elastomeric base layer. In an alternative aspect an adhesive or strip of double sided tape can be applied to the bare portion of the elastomeric base layer.

FIG. 4B shows protection device 300 in a partially assembled state in which the protection device is partially wrapped around the cable connection 310. FIG. 4C shows protection device 300 in a fully assembled state wherein the hooks can grip into the fabric backing on the second major surface of the elastomeric sheet or to a supplemental strip of mating hooks (not shown) attached adjacent to the second longitudinal edge on the second major surface of the elastomeric base layer. In FIG. 4D, a plurality of bands 340 have been wrapped around protection device 300 to make sure the device is well secured over the cable connection. In this exemplary view the hook and loop closure mechanism 337 can be used as a temporary closure mechanism, to aid in the accurate and rapid positioning of the protection device. The bands provide the permanent closure mechanism to secure the protection device of the cable connection.

One major advantage of the exemplary low profile protection device describe herein is its simplicity. Because the body of the protection device can be created in a flat sheet rather than a preformed molded component, the protection device can be easily customized for a given application or niche market. By coating the sealant material on a large area of the elastomeric base layer and subsequent converting of this sealant web by cutting the sheet to size, the protection device can be economically produced. Adding the closure mechanism after the converting step allows further customization of the final protection device.

Another advantage of the exemplary protection devices is that they can be used in applications where there is very little clearance between adjacent connections with a solution that can be quickly and easily installed.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

What is claimed is:

1. A low profile protection device for protecting a cable connection, the device comprising:
an elastomeric base layer having a first longitudinal edge and a second longitudinal edge, wherein the first and second longitudinal edges are substantially parallel in an assembled state and wherein a portion of the first longitudinal edge is obliquely oriented to a portion of the second longitudinal edge in an unassembled state;
a gel sealant material coated on the elastomeric base layer; and
a closure mechanism disposed along the protection device,
wherein the protection device exerts a compressive force around the cable connection when disposed in its assembled state.

2. The protection device of claim 1, wherein the cable connection is an asymmetric cable connection.

3. The protection device of claim 2, wherein the asymmetric cable connection is characterized by a first diameter at a first end of the cable connection that is larger than a second diameter at a second end of the cable connection, and
wherein the protection device is wider at a first end of the protection device than at a second end of the protection device.

4. The protection device of claim 1, wherein the elastomeric base layer is a volume compliant material.

5. The protection device of claim 1, wherein the gel sealant material comprises an oil swollen, cross-linked polymer network.

6. The protection device of claim 1, wherein the protection device has an outer surface that substantially conforms to an external surface of the cable connection such that the outer surface of protection device is less than about 6.5 mm from the external surface of the cable connection.

7. The protection device of claim 1, wherein the protection device has an outer surface that substantially conforms to an external surface of the cable connection such that the outer surface of protection device is less than about 3.2 mm from the external surface of the cable connection.

8. The protection device of claim 1, wherein the closure mechanism is one of a zipper, an eyelet and lace closure, an eyelet and tab closure, a hook and loop style closure, and a series of parallel fastening straps.

9. A low profile protection device for protecting a cable connection, the device comprising:
an elastomeric base layer having a first longitudinal edge and a second longitudinal edge,
a gel sealant material coated on the elastomeric base layer; and
a closure mechanism disposed along the protection device,
wherein the protection device has an outer surface that conforms to an external surface of the cable connection such that the outer surface of protection device is less than about 6.5 mm from the external surface of the cable connection.

10. The protection device of claim 9, wherein the cable connection is an asymmetric cable connection.

11. The protection device of claim 10, wherein the asymmetric cable connection is characterized by a first diameter at a first end of the cable connection that is larger than a second diameter at a second end of the cable connection, and
wherein the protection device is wider at a first end of the protection device than at a second end of the protection device.
